(19) United States
(12) Patent Application Publication
(10) Pub. No.: US 2025/0293442 A1
(43) Pub. Date: Sep. 18, 2025

(54) ANTENNA CONSTELLATION RADIATION ALIGNMENT

(71) Applicant: Meta Platforms Technologies, LLC, Menlo Park, CA (US)

(72) Inventors: Md Rashidul Islam, Fremont, CA (US); Bruno Cendon Martin, Palo Alto, CA (US); Liang Han, Sunnyvale, CA (US); Shabnam Ladan, Mountain, CA (US)

(21) Appl. No.: 18/602,153

(22) Filed: Mar. 12, 2024

(51) Int. Cl. H01Q 25/00; H01Q 1/27

(52) U.S. Cl. CPC H01Q 25/00; H01Q 1/273

(57) ABSTRACT

The disclosed system may include (1) a first wearable device with an antenna array that alternates between different antenna configurations, each of which yields a different radiation pattern, (2) a second wearable device with at least one antenna, and (3) a control module configured to select, for the antenna array in response to a triggering event, an antenna configuration yielding a radiation pattern that, relative to the radiation patterns yielded by the other antenna configurations within the different antenna configurations, results in the highest radiation correlation with a radiation pattern yielded by the second wearable device's at least one antenna. Various other wearable devices, apparatuses, and methods of manufacturing are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an embodiment of a system 100 for aligning antenna constellation radiation between multiple wearable devices.

FIG. 2 depicts an exemplary wearable watch device.

FIG. 3A provides an exemplary depiction of system 100 in which the wearables devices include a wearable watch and a wearable pair of glasses.

FIG. 3B provides an exemplary depiction of system 100 in which the wearables devices include a watch, a pair of glasses, and a user mobile device (e.g., a smart phone).

FIG. 4A depicts exemplary radiation patterns of a watch and a pair of glasses in which one or more activated antennas of the pair of glasses is located on a left side of the pair of glasses and the watch is worn on a left wrist of the user.

FIG. 4B depicts exemplary radiation patterns of a watch and a pair of glasses in which one or more activated antennas of the pair of glasses is located on a left side of the pair of glasses and the watch is worn on a right wrist of the user.

FIG. 5 depicts seven exemplary positions of an exemplary watch.

FIG. 6 depicts an exemplary method for aligning antenna constellation radiation between multiple wearable devices based on position.

FIG. 7 depicts an exemplary flow chart for aligning antenna constellation radiation between multiple wearable devices based on left-handedness or right-handedness.

FIG. 8 depicts an additional exemplary flow chart for aligning antenna constellation radiation between multiple wearable devices based on left-handedness or right-handedness.

FIG. 9 depicts an exemplary pair of artificial reality glasses.

FIG. 10 depicts an exemplary artificial reality headset.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

This disclosure is generally directed to a system for optimizing a radiation correlation (e.g., radiation pattern alignment) between (1) a radiation pattern emitted from a wearable device being worn by a user and (2) a radiation pattern emitted from an additional wearable device being worn by the user (e.g., optimizing a radiation correlation between a watch device and a pair of glasses device). In some examples, the system may optimize the radiation correlation using a dynamically configurable array of antennas integrated with (e.g., embedded within) the wearable device. In these examples, the array of antennas may be configured to alternate between various antenna configurations. The antenna configurations may differ from one another in a variety of ways. In some examples, different antenna configurations may use different subsets of the array's antennas. In these examples, which antennas are turned on (e.g., activated) and which are turned off (disactivated) may differ between the various configurations. Additionally or alternatively, an amplitude and/or phase selected for one or more of the antennas within the array (e.g., one or more of the activated antennas) may vary across the various configurations.

In some examples, the array of antennas may dynamically alternate from one antenna configuration to another in response to a triggering event. In these examples, the array may alternate from one antenna configuration to another in response to a variety of triggers. In some examples, the trigger may be a positional trigger. As a specific example, the wearable device may represent a watch and detecting a change in a position of the watch (e.g., caused by a user moving his arm) may trigger a change in antenna configuration for the array. In additional or alternative examples, the array may include a variety of preconfigured antenna configurations (e.g., one for right-handed users and one for left-handed users). In some such examples, a preconfigured configuration may be selected for a wearable device in response to receiving a user selection (e.g., selecting a right-handed mode or a left-handed mode) and/or determining that the wearable device falls into a specified category (e.g., determining that the wearable device is being worn on a right wrist or a left wrist of a user). In each of these examples, an antenna configuration may be selected that (relative to the other candidate antenna configurations) yields the highest radiation correlation with a radiation pattern of the additional wearable device (e.g., given the triggering event).

Features from any of the embodiments described herein may be used in combination with one another in accordance with the general principles described herein. These and other embodiments, features, and advantages will be more fully understood upon reading the following detailed description in conjunction with the accompanying drawings and claims.

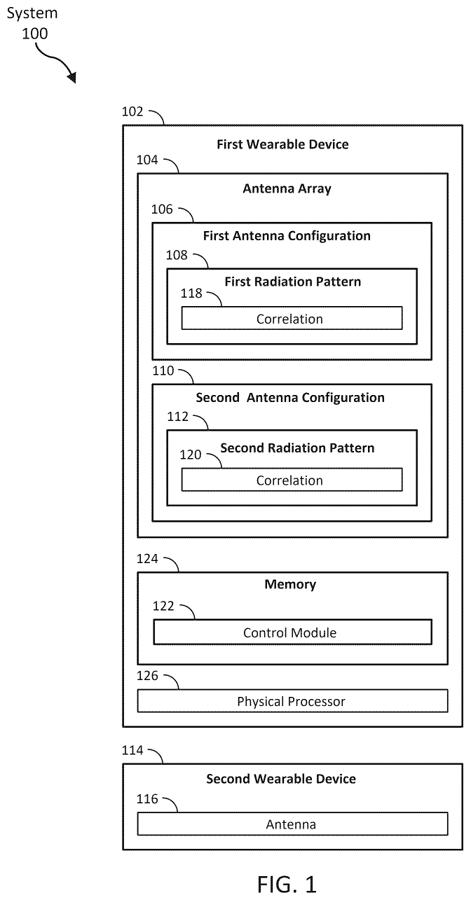

FIG. 1 illustrates an embodiment of a system 100 with a first wearable device 102 that includes an antenna array 104 that can alternate between multiple different antenna configurations (e.g., a first antenna configuration 106 that yields a first radiation pattern 108 and a second antenna configuration 110 that yields a second radiation pattern 112). System 100 may also include a second wearable device 114 that includes at least one antenna (e.g., antenna 116). In some examples, second wearable device 114 may include an antenna array (e.g., that includes antenna 116). In these examples, the antenna array of second wearable device 114 may include any of the features described in connection with antenna array 104.

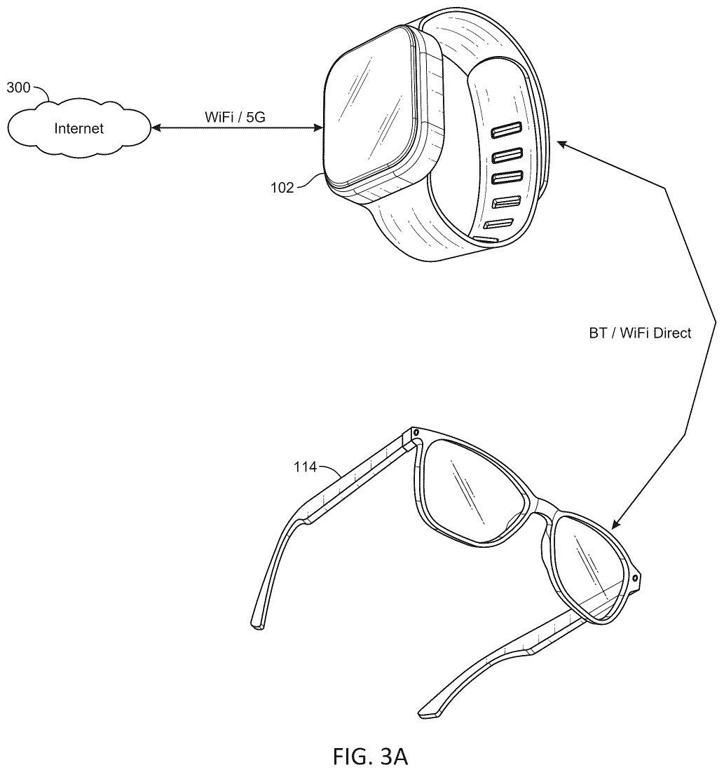

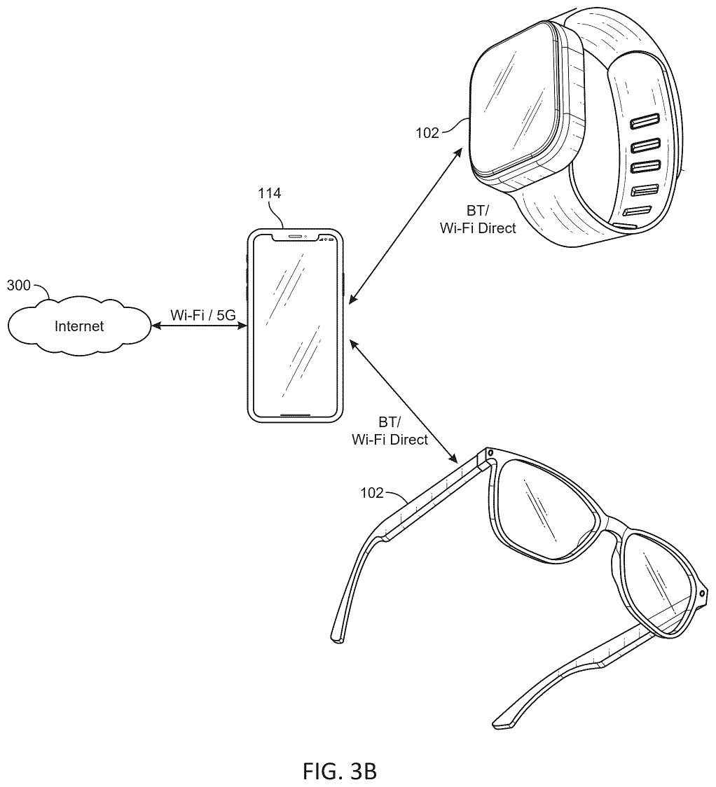

First wearable device 102 and second wearable device 114 may represent any type or form of device. In some examples, first wearable device 102 may represent a watch and second wearable device 114 may represent a pair of glasses (e.g., as depicted in FIG. 3A). Alternatively, first wearable device 102 may represent a pair of glasses and second wearable device 114 may represent a watch. In one embodiment, first wearable device 102 may represent a mobile device and second wearable device 102 may represent a watch and/or a pair of glasses (e.g., as depicted in FIG. 3B). As described throughout this application, first wearable device 102 and second wearable device 114 may communicate wirelessly. In some examples, first wearable device 102 and second wearable device 114 may send data to one another by converting digital data into electromagnetic waves. Each device may include one or more antennas that may transmit the digital data to the other device by radiating the converted electromagnetic waves. The other device may receive the digital data by intercepting the radiated electromagnetic waves, which may then be decoded back into their original digital form. In some examples, the devices may communicate via Bluetooth (e.g., the antennas may radiate electromagnetic waves within a Bluetooth frequency range). Additionally or alternatively, the devices may communicate via Wi-Fi direct (or other wireless technologies such as UWB). In some such examples, the one or more antennas of each device may represent or include Wi-Fi antennas.

While this description focuses on a constellation of devices that includes two devices, it should be appreciated that the disclosed constellation of devices could include any number of device (e.g., beyond two). FIG. 3A depicts an exemplary constellation of devices that includes two devices: a watch (first wearable device 102) and a pair of glasses (second wearable device 114), according to one embodiment. In this exemplary embodiment, (1) first wearable device 102 may communicate with Internet 300 (e.g., via WiFi and/or 5G) and (2) first wearable device 102 and second wearable device 114 may communicate with one another via Bluetooth and/or WiFi Direct. FIG. 3B depicts an exemplary constellation of devices that includes three devices: a user mobile device (second wearable device 114), a watch, and a pair of glasses. In this exemplary embodiment, first wearable device 102 may represent both the watch and the pair of glasses. In this exemplary embodiment, second wearable device 114 communicates with Internet 300 (e.g., via WiFi and/or 5G) and both instances of first wearable device 102 (the watch and the pair of glasses) communicate with second wearable device 114 via Bluetooth and/or WiFi Direct.

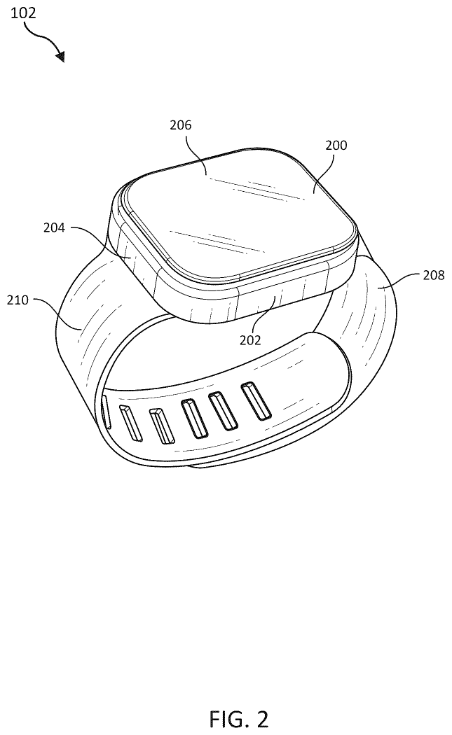

In examples in which first wearable device 102 represents a watch, antenna array 104 may be integrated with first wearable device 102 in a variety of ways and/or at a variety of locations within first wearable device 102. In one embodiment, antenna array 104 may include a first set of antennas embedded within a capsule of first wearable device 102 and a second set of antennas embedded within a band of first wearable device 102. FIG. 2 depicts an exemplary embodiment in which first wearable device 102 represents a watch and includes (1) a first set of antennas embedded within a capsule of first wearable device 102 on each side of the capsule (e.g., at positions 200, 202, 204, and 206) and (2) a second set of antennas embedded within a band of first wearable device 102 on each side of the band (e.g., at positions 208 and 210).

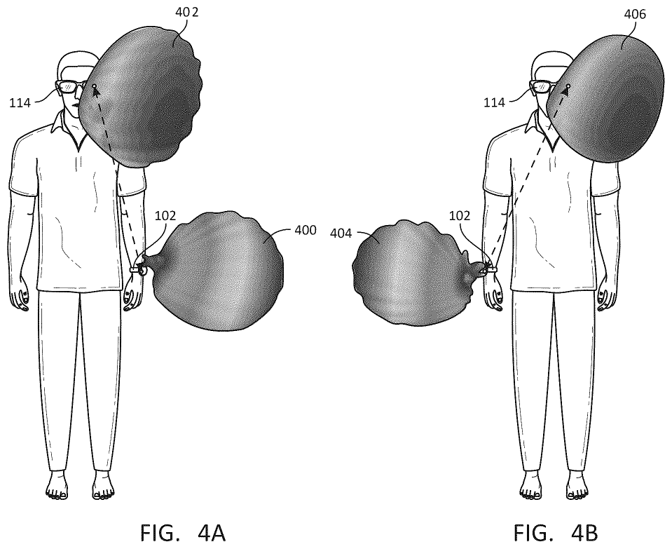

In examples in which second wearable device 114 represents a pair of glasses, the one or more antennas of second wearable device 114 may be integrated with second wearable device 114 in a variety of ways and/or at a variety of locations within second wearable device 114. FIGS. 4A and 4B depict an embodiment in which second wearable device 114 includes two antennas, one positioned on a left side of a frame of second wearable device 114 and another positioned on a right side of a frame of second wearable device 114. While this description, and FIGS. 2 and 4A-4B, focus on embodiments in which first wearable device 102 is a watch and second wearable device 114 is a pair of glasses, it should be appreciated that second wearable device 114 may also be a watch and/or first wearable device 102 may also be a pair of glasses. In embodiments in which second wearable device 114 is a watch, second wearable device 114 may include any of the features of the watch discussed in connection with first wearable device 102. In embodiments in which first wearable device 102 is a pair of glasses, first wearable device 102 may include any of the features of the pair of glasses discussed in connection with second wearable device 114.

Each antenna configuration for antenna array 104 may differ in a variety of ways. In some examples, an antenna configuration may include a designated subset of antennas that is/are activated (e.g., turned on), which may differ from the designated subset of the antennas that is/are activated for one or more of the other antenna configurations. Turning to FIG. 2 as a specific example, (1) a first configuration may include, as activated antennas, 202, 200, and 208, (2) a second configuration may include, as activated antennas, 204, 210, and 206, (3) a third configuration may include, as activated antennas, 202, 206, and 210, etc. In these examples, an antenna configuration may include any possible combination of activated antennas. Additionally or alternatively, an amplitude and/or phase of one or more of activated antennas may vary from the amplitude and/or phase of the one or more antennas in one or more of the other antenna configurations. In some examples, each antenna configuration may include (1) a unique combination of activated antennas and/or (2) a unique combination of amplitudes and/or phases selected for each of the configuration's activated antennas.

Each antenna configuration for antenna array 104 may yield a radiation pattern that results in a different correlation with a radiation pattern yielded by the one or more antennas of second wearable device 114. For example, first radiation pattern 108 yielded by first antenna configuration 106 may result in a correlation 118 with a radiation pattern yielded by the one or more antennas of second wearable device 114. In contrast, second radiation pattern 112 yielded by second antenna configuration 110 may result in a correlation 120 with the radiation pattern yielded by the one or more antennas of second wearable device 114 (e.g., which differs from correlation 118).

In examples in which second wearable device 114 includes an array of multiple antennas, each of first wearable device 102's antenna configurations may result in multiple potential correlations, depending on which antenna configuration is selected for the array of second wearable device 114. As a specific example, if second wearable device 114 includes an antenna array that may alternate between three different antenna configurations, each of first wearable device 102's antenna configurations may result in three potential correlations (e.g., one correlation for each of the three configurations of second wearable device 114).

In addition to first wearable device 102 and second wearable device 114, system 100 may include a control module 122 configured to select, from antenna array 104's various antenna configurations, an antenna configuration that (relative to the other antenna configurations within antenna array 104's various antenna configurations) yields the highest radiation correlation with a radiation pattern yield by the one or more antennas of second wearable device 114. As a specific example, control module 122 may select first radiation pattern 108 (e.g., and apply first radiation pattern 108 to antenna array 104) in response to determining that correlation 118 is higher than correlation 120.

In examples in which second wearable device 114 includes an array of multiple antennas, control module 122 may, in some examples, (1) compare each of antenna array 104's potential correlations resulting from each of first wearable device 102's antenna configurations, (2) determine the combination of antenna configurations (e.g., including an antenna configuration for first wearable device 102 and an antenna configuration for second wearable device 114) that results in the highest correlation, (3) select, for antenna array 104, the antenna configuration corresponding to the determined combination, and (4) select, for the antenna array of second wearable device 114, the antenna configuration corresponding to the determined combination. Alternatively, in such examples control module 122 may (1) receive (e.g., from second wearable device 114 or an intermediary device) an indication of which antenna configuration has been selected for second wearable device 114's antenna array, (2) determine the antenna configuration for antenna array 104 that yields the highest correlation given the antenna configuration that has been selected for second wearable device 114's antenna array, and (3) select, for antenna array 104, the determined antenna configuration. In examples in which a constellation of devices includes more than two wearable devices, control module 122 may determine each possible correlation between the more than two wearable devices and determine an optimal combination of optimal antenna configurations for each wearable device within the constellation.

Control module 122 may select an antenna configuration for antenna array 104 in response to a variety of triggers. In some examples, the trigger may represent a trigger that triggers alternating (e.g., changing) from a current antenna configuration to a new antenna configuration.

In some examples, one or more of the antenna configurations may be a preconfigured configuration configured for a different type (e.g., category) of user and control module 122 may select a preconfigured configuration for antenna array 104 in response to determining that a user wearing first wearable device 102 falls within a type of user corresponding to the preconfigured configuration. For example, the antenna configurations of antenna array 104 may include a first preconfigured configuration for right-handed users and a second preconfigured configuration for left-handed users. In this example, control module 122 may select the antenna configuration that results in the highest radiation correlation by (1) determining whether a user wearing first wearable device 102 is right-handed or left-handed and (2) selecting the first preconfigured configuration in response to determining that the user is right-handed or selecting the second preconfigured configuration in response to determining that the user is left-handed. In one such example, the one or more antennas of second wearable device 114 may include a first antenna (e.g., located on a right side of second wearable device 114) and a second antenna (e.g., located on a left side of second wearable device 114) and control module 122 may further (1) activate the first antenna in response to determining that the user is right-handed (e.g., in response to determining that first wearable device 102 is being worn on a right wrist of the user), (2) activate the second antenna in response to determining that the user is left-handed (e.g., in response to determining that first wearable device 102 is being worn on a left wrist of the user), and/or (3) select an amplitude and/or phase for the first antenna and/or the second antenna in response to determining that the user is right-handed or determining that the user is left-handed.

FIGS. 4A and 4B depict exemplary radiation patterns for a left-handed user (in FIG. 4A) and a right-handed user (in FIG. 4B). In FIG. 4A, first wearable device 102 represents a watch, with a radiation pattern 400 yielded by a selected antenna configuration, and second wearable device 114 represents a pair of glasses, with a radiation pattern 402 yielded by a selected antenna configuration. In FIG. 4B, first wearable device 102 represents a watch, with a radiation pattern 404 yielded by a selected antenna configuration, and second wearable device 114 represents a pair of glasses, with a radiation pattern 406 yielded by a selected antenna configuration. As shown in these figures, activating an antenna on a left side of a pair of glasses may yield a better correlation for a left-handed user than for a right-handed user. In some examples, control module 122 may also select an antenna configuration based on interference, scattering from nearby objects etc. For example, as shown in FIG. 4B, activating an antenna on a left side of a pair of glasses for a watch being worn on a right hand may result in poor reception to the antenna correlation between the pair of glasses and the watch (e.g., caused by the user's body). In this example, control module 122 may select (1) to activate the antenna on the right side of the pair of glasses for right-handed users or (2) to activate the antenna on the left side of the pair of glasses for left-handed user based at least in part on the determination that using the antenna on the right side for left-handed users, or the antenna on the left side for right-handed users, will result in poor reception/interference caused by the body of the user.

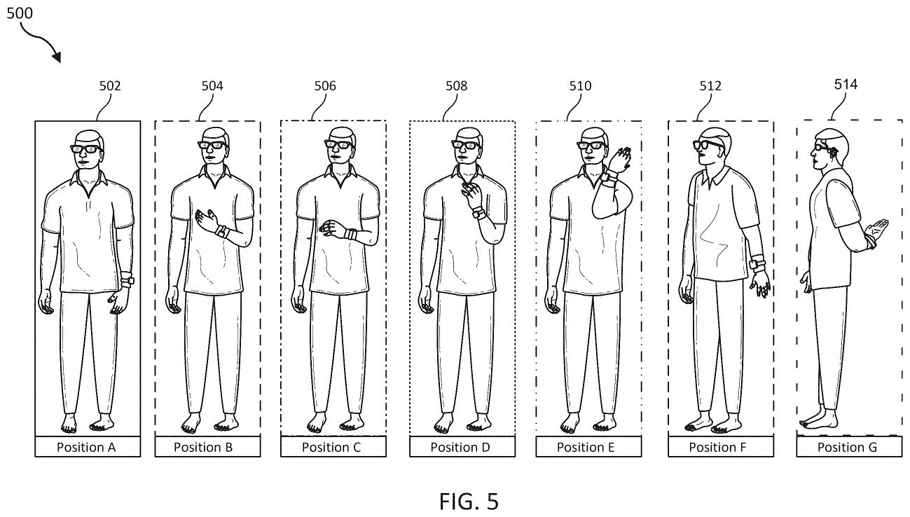

In some examples, control module 122 may be configured to detect a position of first wearable device 102 (e.g., relative to second wearable device 114). In these examples, control module 122 may, in response to detecting the position, select the antenna configuration for antenna array 104 that yields the highest correlation (between the radiation patterns of first antenna configuration 106 and second antenna configuration 110) given the position of the first wearable device 102 (e.g., relative to the position of second wearable device 114). FIG. 5 depicts a variety of positions 500 (e.g., 502, 504, 506, 508, 510, 512, and/or 514) that may be detected for first wearable device 102 in one embodiment. In one embodiment, the antenna configurations for antenna array 104 may represent and/or include a set of configurations, each of which corresponds to a different position (e.g., each of which results in an optimal correlation given a different position for first wearable device 102 relative to second wearable device 114).

In some examples in which control module 122 selects an antenna configuration for antenna array 104 based on position, control module 122 my select the antenna configuration based on just the position of first wearable device 102 or just the position of second wearable device 114 (e.g., relative to an assumed default position of the other wearable device). In other examples, control module 122 my select the antenna configuration based on both a determined position of first wearable device 102 and a determined position of second wearable device 114. In some examples, control module 122 may be configured to select an antenna configuration for antenna array 104 (e.g., a change in antenna configuration) in response to detecting a change in position (e.g., for first wearable device 102 and/or second wearable device 114).

In some examples, control module 122 may be configured to detect a change in a radiation pattern yielded by second wearable device 114 (e.g., caused by interference, scattering, a change in position, an external environmental change, etc.). In one such example, control module 122 may be configured to select an antenna configuration for antenna array 104 (e.g., a change in antenna configuration) in response to detecting the change in the radiation pattern yielded by second wearable device 114.

Control module 122 may operate in and/or across a variety of devices. In some examples, control module 122 may operate as part of first wearable device 102, second wearable device 114, and/or a controller device. For example, in embodiments in which system 100 includes a watch, a pair of glasses, and a mobile device, control module 122 may operate within the watch, the pair of glasses, and/or the mobile device. In some examples, each of the devices may include a different control module (e.g., and control module may select an antenna configuration for its corresponding device). In other examples, one control module may select an antenna configuration for multiple devices (e.g., for both first wearable device 102 and second wearable device 114).

The antennas described herein may refer to any type or form of device that transmits and/or receives radio frequency signals. In some examples, the antennas may enable wireless communication between different devices (e.g., via Bluetooth or WiFi).

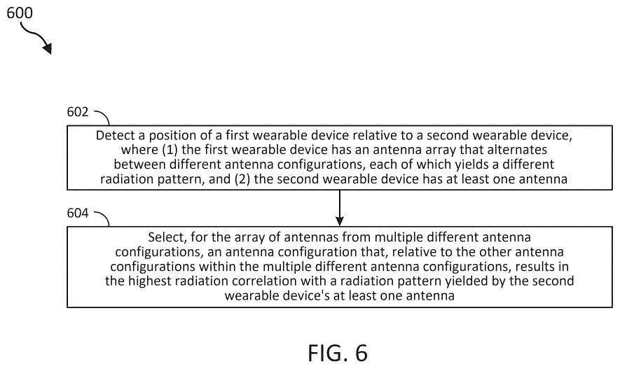

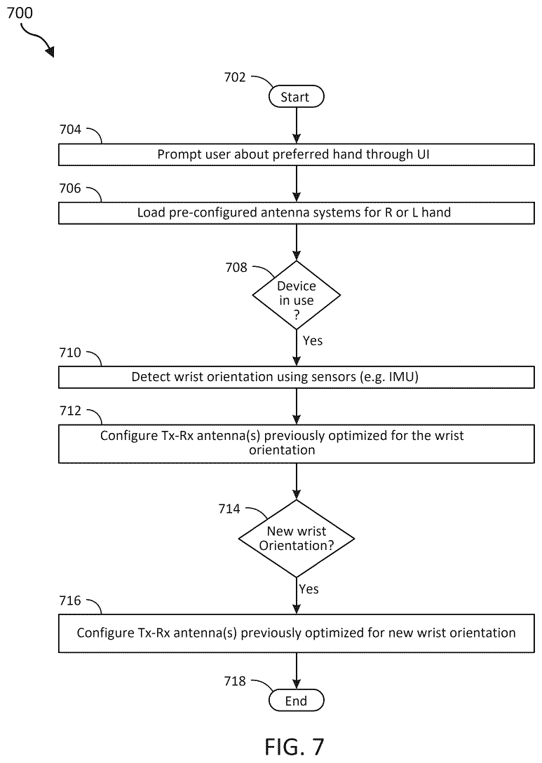

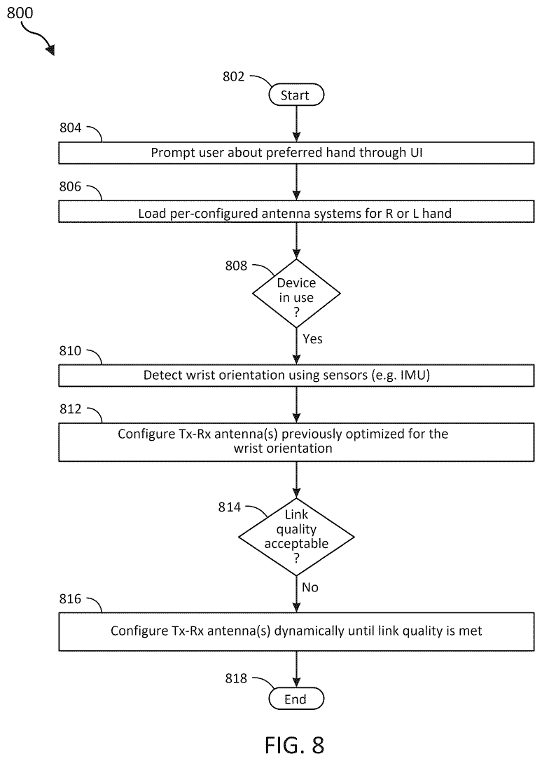

FIG. 6 is a flow diagram of an exemplary computer-implemented method 600. FIG. 7 is a flow diagram of an exemplary computer-implemented method 700. And FIG. 8 is a flow diagram of an exemplary computer-implemented method 800. The steps shown in these three figures may be performed by any suitable computer-executable code and/or computing system, including the system(s) illustrated in FIG. 1, FIG. 3A, and/or FIG. 3B. For example, the steps shown may be performed by modules operating in a user device such as first wearable device 102 and/or second wearable device 114. In one example, one or more of the steps may represent an algorithm whose structure includes and/or is represented by multiple sub-steps, examples of which will be provided in greater detail below. The user device (e.g., performing the steps shown in FIGS. 6, 7, and/or 8) may represent any type or form of computing device capable of reading computer-executable instructions.

FIG. 6 is a flow diagram relating to selecting an antenna configuration (e.g., using one or more of the features described in connection with FIG. 1) based on position. At step 602 in FIG. 6, one or more of the systems described herein (e.g., control module 122) may detect a position of a first wearable device (e.g., first wearable device 102 in FIG. 1) relative to a second wearable device (e.g., second wearable device 114). At step 604, the one or more systems may select, for an antenna array of the first wearable device (e.g., antenna array 104) from multiple different antenna configurations (e.g., first antenna configuration 106 and second antenna configuration 110), an antenna configuration that, relative to the other antenna configurations within the multiple different antenna configurations, results in the highest radiation correlation with a radiation pattern yielded by one or more antennas of the second wearable device.

FIG. 7 is a flow diagram, starting at step 702, relating to selecting an antenna configuration (e.g., using one or more of the features described in connection with FIG. 1) based on wrist orientation (e.g., left-handedness or right-handedness). At step 704, one or more of the systems described herein may prompt a user about the user's preferred hand (e.g., left hand or right hand) through a user interface (e.g., a user interface presented via a display element of first wearable device 102, second wearable device 114, and/or a mobile device such as a smart phone). Based on the user's response, the one or more systems may, at step 706, load pre-configured antenna systems (e.g., an antenna configuration for antenna array 104) corresponding to right-handedness or left-handedness. At step 708, the one or more systems may detect that a device (e.g., first wearable device 102) is in use and, in response, may (at step 710) detect a wrist orientation (e.g., using one or more sensors of the device such as an Inertial Measurement Unit (IMU) sensor) that matches the preferred hand indicated by the user's response at step 704. At step 712, the one or more systems may configure the one or more antennas of the device (e.g., Tx and/or Rx antennas) using the pre-configured antenna systems (e.g., antenna configuration) loaded at step 706. In some examples, at step 714, the one or more systems may detect a new wrist orientation. In response, the one or more systems, at step 716, may configure the one or more antennas using a different pre-configured antenna system (e.g., optimized for the new wrist orientation). The steps of FIG. 7 end at 718.

FIG. 8 is a flow diagram, starting at step 802, relating to selecting an antenna configuration (e.g., using one or more of the features described in connection with FIG. 1) based on both wrist orientation (e.g., left-handedness or right-handedness) and a link quality assessment. Steps 802-812 mirror steps 702-712 of FIG. 7. At step 814, the one or more systems may determine whether a link quality (e.g., RSSI, SNR) is acceptable (e.g., exceeds a threshold quality metric). If the link quality is unacceptable (e.g., falls below the threshold quality metric), the one or more systems may, at step 816, dynamically configure the antennas of antenna array 104 (e.g., changing from one antenna configuration to another) until link quality is met (e.g., until the link quality exceeds the threshold quality metric). FIG. 8 ends at step 818.

### EXAMPLE EMBODIMENTS

Example 1: A system including a first wearable device with an antenna array that alternates between multiple different antenna configurations, each of which yields a different radiation pattern, a second wearable device including at least one antenna, and a control module configured to select, for the antenna array in response to a triggering event, an antenna configuration yielding a radiation pattern that, relative to the radiation patterns yielded by the other antenna configurations within the multiple different antenna configurations, results in the highest radiation correlation with a radiation pattern yielded by the second wearable device's at least one antenna.

Example 2: The system of example 1, where the control module is further configured to detect a position of the first wearable device relative to the second wearable device, the triggering event comprises detecting a change in position, and the antenna configuration yielding the highest radiation correlation comprises the antenna configuration that yields the highest radiation correlation given the position of the first wearable device relative to the second wearable device.

Example 3: The system of examples 1-2, where each antenna configuration is defined by which antennas within the antenna configuration are activated and/or an amplitude and/or phase of one or more activated antennas.

Example 4: The system of example 3, where each antenna configuration within the multiple antenna configurations varies, relative to the other antenna configurations, with respect to which antennas are activated and/or the amplitude and/or phase of one or more activated antennas.

Example 5: The system of examples 3-4, where the amplitude and/or phase of the one or more activated antennas includes an amplitude-phase combination of the antennas.

Example 6: The system of example 1, where the control module is further configured to detect changes in the radiation pattern yielded by the second wearable device's at least one antenna and the triggering event includes detecting a change in the radiation pattern yielded by the second wearable device's at least one antenna.

Example 7: The system of examples 1-6, where the first wearable device is a watch and the second wearable device is a pair of glasses.

Example 8: The system of example 7, where the antenna array includes one or more antennas on a capsule of the watch (e.g., multiple antennas on the capsule) and/or one or more antennas on a band of the watch (e.g., multiple antennas on the band).

Example 9: The system of examples 7-8, where the multiple different antenna configuration includes a first preconfigured configuration for right-handed users and a second preconfigured configuration for left-handed users, the control module is further configured to determine whether a user wearing the first and second wearable devices is right-handed or left-handed, the triggering event includes determining whether the user is right-handed or left-handed, and selecting the antenna configuration yielding the radiation pattern resulting in the highest radiation correlation includes selecting the first preconfigured configuration in response to determining that the user is right-handed or selecting the second preconfigured configuration in response to determining that the user is left-handed.

Example 10: The system of example 9, where the at least one antenna of the second wearable device includes a first antenna and a second antenna and the control module is further configured to activate the first antenna in response to determining that the user is right-handed, activate the second antenna in response to determining that the user is left-handed, and/or select an amplitude for at least one of the first antenna or the second antenna in response to determining that the user is right-handed or determining that the user is left-handed.

Example 11: The system of example 10, where the first antenna is positioned on the right side of the second wearable device, and the second antenna is positioned on the left side of the second wearable device.

Example 12: The system of examples 10-11, where the second wearable device includes an additional array of antennas with multiple antennas including the at least one antenna, the additional array of antennas alternates between an additional multitude of different antenna configurations, each of which yields a different radiation pattern, and the control module is further configured to select, for the additional array of antenna in response to the triggering event, an antenna configuration with a radiation pattern that yields the highest radiation correlation between first wearable device and the second wearable device, relative to the radiation patterns of the other antenna configurations within the additional plurality of different antenna configurations.

Example 13: A computer-implemented method including (1) detecting a position of a first wearable device relative to a second wearable device, where the first wearable device includes an antenna array that alternates between multiple different antenna configurations, each of which yields a different radiation pattern, and the second wearable device includes at least one antenna, and in response to detecting the position, (2) selecting, for the antenna array from the multiple different antenna configurations, an antenna configuration that, relative to the other antenna configurations within the multiple different antenna configurations, results in the highest radiation correlation with a radiation pattern yielded by the second wearable device's at least one antenna.

Example 14: The computer-implemented method of example 13, where each antenna configuration is defined by which antennas within the antenna configuration are activated and/or an amplitude of one or more activated antennas.

Example 15: The computer-implemented method of example 14, where each antenna configuration within the multiple antenna configurations varies, relative to the other antenna configurations, with respect to at least one of which antennas are activated or the amplitude and/or phase of one or more activated antennas.

Example 16: The computer-implemented method of examples 14-15, where the amplitude or phase of the one or more activated antennas includes an amplitude-phase combination.

Example 17: The computer-implemented method of examples 13-16, where the first wearable device is a watch and the second wearable device is a pair of glasses.

Example 18: A wearable device including an antenna array that alternates between multiple different antenna configurations, each of which yields a different radiation pattern, and a control module configured to select, for the antenna array in response to a triggering event, an antenna configuration yielding a radiation pattern that, relative to the radiation patterns yielded by the other antenna configurations within the multiple different antenna configurations, results in the highest radiation correlation with a radiation pattern yielded by one or more antennas of an additional wearable device.

Example 19: The wearable device of example 18, where the wearable device is a watch and the additional wearable device is a pair of glasses.

Example 20: The wearable device of examples 18-19, where the wearable device is a pair of glasses, and the additional wearable device is a watch.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof.

Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

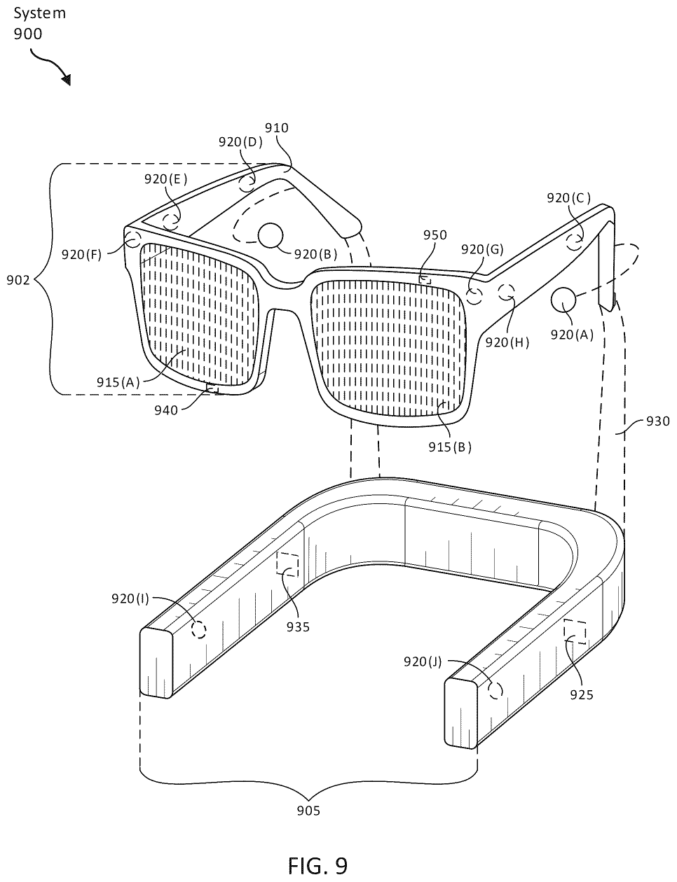

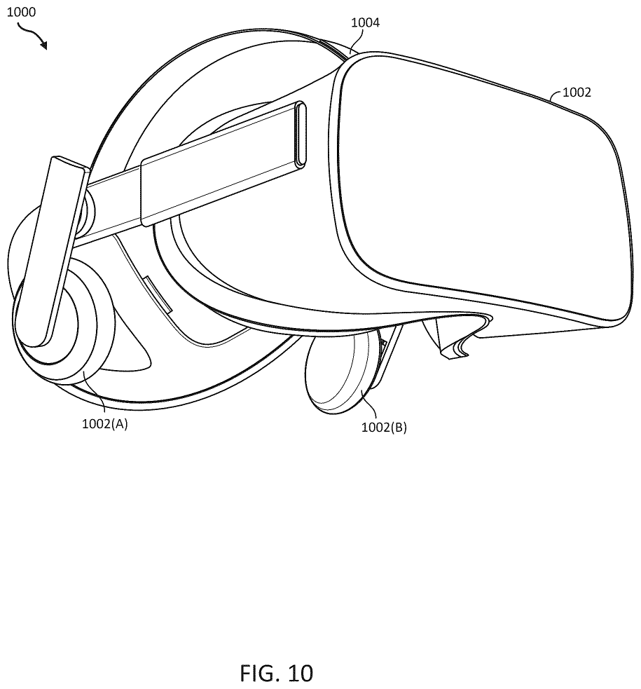

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 900 in FIG. 9) or that visually immerses a user in an artificial reality (such as, e.g., virtual-reality system 1000 in FIG. 10). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 9, augmented-reality system 900 may include an eyewear device 902 with a frame 910 configured to hold a left display device 915(A) and a right display device 915(B) in front of a user's eyes. Display devices 915(A) and 915(B) may act together or independently to present an image or series of images to a user. While augmented-reality system 900 includes two displays, embodiments of this disclosure may be implemented in augmented-reality systems with a single NED or more than two NEDs.

In some embodiments, augmented-reality system 900 may include one or more sensors, such as sensor 940. Sensor 940 may generate measurement signals in response to motion of augmented-reality system 900 and may be located on substantially any portion of frame 910. Sensor 940 may represent one or more of a variety of different sensing mechanisms, such as a position sensor, an inertial measurement unit (IMU), a depth camera assembly, a structured light emitter and/or detector, or any combination thereof. In some embodiments, augmented-reality system 900 may or may not include sensor 940 or may include more than one sensor. In embodiments in which sensor 940 includes an IMU, the IMU may generate calibration data based on measurement signals from sensor 940. Examples of sensor 940 may include, without limitation, accelerometers, gyroscopes, magnetometers, other suitable types of sensors that detect motion, sensors used for error correction of the IMU, or some combination thereof.

In some examples, augmented-reality system 900 may also include a microphone array with a plurality of acoustic transducers 920(A)-920(J), referred to collectively as acoustic transducers 920. Acoustic transducers 920 may represent transducers that detect air pressure variations induced by sound waves. Each acoustic transducer 920 may be configured to detect sound and convert the detected sound into an electronic format (e.g., an analog or digital format). The microphone array in FIG. 9 may include, for example, ten acoustic transducers: 920(A) and 920(B), which may be designed to be placed inside a corresponding ear of the user, acoustic transducers 920(C), 920(D), 920(E), 920(F), 920(G), and 920(H), which may be positioned at various locations on frame 910, and/or acoustic transducers 920(I) and 920(J), which may be positioned on a corresponding neckband 905.

In some embodiments, one or more of acoustic transducers 920(A)-(J) may be used as output transducers (e.g., speakers). For example, acoustic transducers 920(A) and/or 920(B) may be earbuds or any other suitable type of headphone or speaker.

The configuration of acoustic transducers 920 of the microphone array may vary. While augmented-reality system 900 is shown in FIG. 9 as having ten acoustic transducers 920, the number of acoustic transducers 920 may be greater or less than ten. In some embodiments, using higher numbers of acoustic transducers 920 may increase the amount of audio information collected and/or the sensitivity and accuracy of the audio information. In contrast, using a lower number of acoustic transducers 920 may decrease the computing power required by an associated controller 950 to process the collected audio information. In addition, the position of each acoustic transducer 920 of the microphone array may vary. For example, the position of an acoustic transducer 920 may include a defined position on the user, a defined coordinate on frame 910, an orientation associated with each acoustic transducer 920, or some combination thereof.

Acoustic transducers 920(A) and 920(B) may be positioned on different parts of the user's ear, such as behind the pinna, behind the tragus, and/or within the auricle or fossa. Or, there may be additional acoustic transducers 920 on or surrounding the ear in addition to acoustic transducers 920 inside the ear canal. Having an acoustic transducer 920 positioned next to an ear canal of a user may enable the microphone array to collect information on how sounds arrive at the ear canal. By positioning at least two of acoustic transducers 920 on either side of a user's head (e.g., as binaural microphones), augmented reality system 900 may simulate binaural hearing and capture a 3D stereo sound field around about a user's head. In some embodiments, acoustic transducers 920(A) and 920(B) may be connected to augmented-reality system 900 via a wired connection 930, and in other embodiments acoustic transducers 920(A) and 920(B) may be connected to augmented-reality system 900 via a wireless connection (e.g., a BLUETOOTH connection). In still other embodiments, acoustic transducers 920(A) and 920(B) may not be used at all in conjunction with augmented-reality system 900.

Acoustic transducers 920 on frame 910 may be positioned in a variety of different ways, including along the length of the temples, across the bridge, above or below display devices 915(A) and 915(B), or some combination thereof. Acoustic transducers 920 may also be oriented such that the microphone array is able to detect sounds in a wide range of directions surrounding the user wearing the augmented reality system 900. In some embodiments, an optimization process may be performed during manufacturing of augmented-reality system 900 to determine relative positioning of each acoustic transducer 920 in the microphone array.

In some examples, augmented-reality system 900 may include or be connected to an external device (e.g., a paired device), such as neckband 905. Neckband 905 generally represents any type or form of paired device. Thus, the following discussion of neckband 905 may also apply to various other paired devices, such as charging cases, smart watches, smart phones, wrist bands, other wearable devices, hand-held controllers, tablet computers, laptop computers, other external compute devices, etc.

As shown, neckband 905 may be coupled to eyewear device 902 via one or more connectors. The connectors may be wired or wireless and may include electrical and/or non-electrical (e.g., structural) components. In some cases, eyewear device 902 and neckband 905 may operate independently without any wired or wireless connection between them. While FIG. 9 illustrates the components of eyewear device 902 and neckband 905 in example locations on eyewear device 902 and neckband 905, the components may be located elsewhere and/or distributed differently on eyewear device 902 and/or neckband 905. In some embodiments, the components of eyewear device 902 and neckband 905 may be located on one or more additional peripheral devices paired with eyewear device 902, neckband 905, or some combination thereof.

Pairing external devices, such as neckband 905, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 900 may be provided by a paired device or shared between a paired device and an eyewear device, thus reducing the weight, heat profile, and form factor of the eyewear device overall while still retaining desired functionality.

For example, neckband 905 may allow components that would otherwise be included on an eyewear device to be included in neckband 905 since users may tolerate a heavier weight load on their shoulders than they would tolerate on their heads. Neckband 905 may also have a larger surface area over which to diffuse and disperse heat to the ambient environment. Thus, neckband 905 may allow for greater battery and computation capacity than might otherwise have been possible on a stand-alone eyewear device. Since weight carried in neckband 905 may be less invasive to a user than weight carried in eyewear device 902, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 905 may be communicatively coupled with eyewear device 902 and/or to other devices. These other devices may provide certain functions (e.g., tracking, localizing, depth mapping, processing, storage, etc.) to augmented-reality system 900. In the embodiment of FIG. 9, neckband 905 may include two acoustic transducers (e.g., 920(I) and 920(J)) that are part of the microphone array (or potentially form their own microphone subarray). Neckband 905 may also include a controller 925 and a power source 935.

Acoustic transducers 920(I) and 920(J) of neckband 905 may be configured to detect sound and convert the detected sound into an electronic format (analog or digital). In the embodiment of FIG. 9, acoustic transducers 920(I) and 920(J) may be positioned on neckband 905, thereby increasing the distance between the neckband acoustic transducers 920(I) and 920(J) and other acoustic transducers 920 positioned on eyewear device 902. In some cases, increasing the distance between acoustic transducers 920 of the microphone array may improve the accuracy of beamforming performed via the microphone array. For example, if a sound is detected by acoustic transducers 920(C) and 920(D) and the distance between acoustic transducers 920(C) and 920(D) is greater than, e.g., the distance between acoustic transducers 920(D) and 920(E), the determined source location of the detected sound may be more accurate than if the sound had been detected by acoustic transducers 920(D) and 920(E).

Controller 925 of neckband 905 may process information generated by the sensors on neckband 905 and/or augmented-reality system 900. For example, controller 925 may process information from the microphone array that describes sounds detected by the microphone array. For each detected sound, controller 925 may perform a direction-of-arrival (DOA) estimation to estimate a direction from which the detected sound arrived at the microphone array. As the microphone array detects sounds, controller 925 may populate an audio data set with the information.

In embodiments in which augmented-reality system 900 includes an inertial measurement unit, controller 925 may compute all inertial and spatial calculations from the IMU located on eyewear device 902. A connector may convey information between augmented-reality system 900 and neckband 905 and between augmented-reality system 900 and controller 925. The information may be in the form of optical data, electrical data, wireless data, or any other transmittable data form. Moving the processing of information generated by augmented-reality system 900 to neckband 905 may reduce weight and heat in eyewear device 902, making it more comfortable to the user.

Power source 935 in neckband 905 may provide power to eyewear device 902 and/or to neckband 905. Power source 935 may include, without limitation, lithium-ion batteries, lithium-polymer batteries, primary lithium batteries, alkaline batteries, or any other form of power storage. In some cases, power source 935 may be a wired power source. Including power source 935 on neckband 905 instead of on eyewear device 902 may help better distribute the weight and heat generated by power source 935.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1000 in FIG. 10, that mostly or completely covers a user's field of view. Virtual-reality system 1000 may include a front rigid body 1002 and a band 1004 shaped to fit around a user's head. Virtual-reality system 1000 may also include output audio transducers 1006(A) and 1006(B). Furthermore, while not shown in FIG. 10, front rigid body 1002 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 900 and/or virtual-reality system 1000 may include one or more liquid crystal displays (LCDs), light emitting diode (LED) displays, microLED displays, organic LED (OLED) displays, digital light projector (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 900 and/or virtual-reality system 1000 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 900 and/or virtual-reality system 1000 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world.

Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device (e.g., memory 124 in FIG. 1) and at least one physical processor (e.g., physical processor 126 in FIG. 1).

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

User interfaces corresponding to the methods and systems described above may be surfaced as part of a variety of navigational flows. In some examples, a navigational flow may include a combination of user interfaces described herein and additional user interfaces not described herein. Each user interface described herein may be surfaced from a variety of entry points. In some examples, the user interfaces described here may be interconnected (e.g., with one interface navigating to another).

Each of the computer-mediated actions described herein may be performed by a module (e.g., control module 122) that operates within an endpoint device (e.g., first wearable device 102 and/or second wearable device 114) and/or that operates within a backend server. In the examples in which an action involves presenting digital content to a user via an endpoint device and/or receiving user input and/or digital feedback from the user to the endpoint device, the module may perform the action directly, in examples in which the module operates within the endpoint device (e.g., by displaying content via a display element of the endpoint, receiving tapping input to a touchscreen of the endpoint device, and/or receiving input to an auxiliary device communicatively coupled to the endpoint device such a digital mouse and/or a keyboard), and/or indirectly (e.g., in examples in which the module operates within the server). In examples in which a module performs an action indirectly, the module may perform the action in a variety of ways. For example, the module may perform the action by instructing the endpoint device to perform the action, by transmitting content to the endpoint device to be presented by the endpoint device, by providing the endpoint with an application that performs the action, by receiving an indication of user input to the endpoint device from the endpoint device, etc. Additionally, in some examples, the module may perform an action operating in a combination of an endpoint device and a backend server.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a first wearable device comprising an antenna array that alternates between a plurality of different antenna configurations, each of which yields a different radiation pattern;
a second wearable device comprising at least one antenna; and
a control module configured to select, for the antenna array in response to a triggering event, an antenna configuration yielding a radiation pattern that, relative to the radiation patterns yielded by the other antenna configurations within the plurality of different antenna configurations, results in the highest radiation correlation with a radiation pattern yielded by the second wearable device's at least one antenna.

2. The system of claim 1, wherein:
the control module is further configured to detect a position of the first wearable device relative to the second wearable device;
the triggering event comprises detecting a change in position; and
the antenna configuration yielding the highest radiation correlation comprises the antenna configuration that yields the highest radiation correlation given the position of the first wearable device relative to the second wearable device.

3. The system of claim 1, wherein each antenna configuration within the plurality of antenna configurations varies, relative to the other antenna configurations, with respect to at least one of:
which antennas are activated; or
at least one of an amplitude or a phase of one or more activated antennas.

4. The system of claim 3, wherein the amplitude or phase of the one or more activated antennas comprises an amplitude-phase combination of the one or more activated antennas.

5. The system of claim 1, wherein:
the control module is further configured to detect changes in the radiation pattern yielded by the second wearable device's at least one antenna; and
the triggering event comprises detecting a change in the radiation pattern yielded by the second wearable device's at least one antenna.

6. The system of claim 1, wherein:
the first wearable device is a watch; and
the second wearable device is a pair of glasses.

7. The system of claim 6, wherein the antenna array comprises at least one of:
one or more antennas on a capsule of the watch; or
one or more antennas on a band of the watch.

8. The system of claim 7, wherein at least one of:
the one or more antennas on the capsule comprises a plurality of antennas; or
the one or more antennas on the band comprises a plurality of antennas.

9. The system of claim 7, wherein:
the plurality of different antenna configuration comprises a first preconfigured configuration for right-handed users and a second preconfigured configuration for left-handed users;
the control module is further configured to determine whether a user wearing the first and second wearable devices is right-handed or left-handed;
the triggering event comprises determining whether the user is right-handed or left-handed; and
selecting the antenna configuration yielding the radiation pattern resulting in the highest radiation correlation comprises:
selecting the first preconfigured configuration in response to determining that the user is right-handed; or
selecting the second preconfigured configuration in response to determining that the user is left-handed.

10. The system of claim 9, wherein:
the at least one antenna of the second wearable device comprises a first antenna and a second antenna; and
the control module is further configured to at least one of:
activate the first antenna in response to determining that the user is right-handed;
activate the second antenna in response to determining that the user is left-handed; or
select at least one of an amplitude or a phase for at least one of the first antenna or the second antenna in response to determining that the user is right-handed or determining that the user is left-handed.

11. The system of claim 10, wherein:
the first antenna is positioned on a right side of the second wearable device; and
the second antenna is positioned on a left side of the second wearable device.

12. The system of claim 1, wherein:
the second wearable device comprises an additional array of antennas with a plurality of antennas comprising the at least one antenna;
the additional array of antennas alternates between an additional plurality of different antenna configurations, each of which yields a different radiation pattern; and
the control module is further configured to select, for the additional array of antenna in response to the triggering event, an antenna configuration with a radiation pattern that yields the highest radiation correlation between first wearable device and the second wearable device, relative to the radiation patterns of the other antenna configurations within the additional plurality of different antenna configurations.

13. A computer-implemented method comprising:
detecting a position of a first wearable device relative to a second wearable device, wherein:
the first wearable device comprises an antenna array that alternates between a plurality of different antenna configurations, each of which yields a different radiation pattern; and
the second wearable device comprises at least one antenna; and
in response to detecting the position, selecting, for the antenna array from the plurality of different antenna configurations, an antenna configuration that, relative to the other antenna configurations within the plurality of different antenna configurations, results in the highest radiation correlation with a radiation pattern yielded by the second wearable device's at least one antenna.

14. The computer-implemented method of claim 13, wherein each antenna configuration is defined by at least one of:
which antennas within the antenna configuration are activated; or
at least one of an amplitude or phase of one or more activated antennas.

15. The computer-implemented method of claim 14, wherein each antenna configuration within the plurality of antenna configurations varies, relative to the other antenna configurations, with respect to at least one of:
which antennas are activated; or
at least one of the amplitude or the phase of one or more activated antennas.

16. The computer-implemented method of claim 14, wherein the amplitude or the phase of the one or more activated antennas comprises an amplitude-phase combination of the one or more activated antennas.

17. The computer-implemented method of claim 13, wherein:
the first wearable device is a watch; and
the second wearable device is a pair of glasses.

18. A wearable device comprising:
an antenna array that alternates between a plurality of different antenna configurations, each of which yields a different radiation pattern; and
a control module configured to select, for the antenna array in response to a triggering event, an antenna configuration yielding a radiation pattern that, relative to the radiation patterns yielded by the other antenna configurations within the plurality of different antenna configurations, results in the highest radiation correlation with a radiation pattern yielded by one or more antennas of an additional wearable device.

19. The wearable device of claim 18, wherein:
the wearable device is a watch; and
the additional wearable device is a pair of glasses.

20. The wearable device of claim 18, wherein:
the wearable device is a pair of glasses; and
the additional wearable device is a watch.
